(19) United States
(12) Patent Application Publication
(10) Pub. No.: US 2024/0378374 A1
(43) Pub. Date: Nov. 14, 2024

(54) EDITABLE FORM FIELD DETECTION

(71) Applicant: Apple Inc., Cupertino, CA (US)

(72) Inventors: Ryan S. DIXON, Redwood City, CA (US); Adrien DELAYE, Sunnyvale, CA (US); Jun HATORI, Cupertino, CA (US); Thomas DESELAERS, Zurich (CH)

(21) Appl. No.: 18/374,657

(22) Filed: Sep. 28, 2023

Related U.S. Application Data
(60) Provisional application No. 63/465,220, filed on May 9, 2023.

(51) Int. Cl. G06F 40/174; G06T 11/60

(52) U.S. Cl. CPC G06F 40/174; G06T 11/60; G06T 2210/12

(57) ABSTRACT

Aspects of the subject technology include obtaining form data corresponding to a form. The form includes one or more lines of text of the form and one or more fields of the form. Aspects also include determining one or more text attributes of the one or more lines of text of the form. The one or more text attributes include at least one of semantic information or geometric information. Aspects also include identifying the one or more fields of the form based at least in part on the determined one or more text attributes and displaying the form data with an indication of the identified one or more fields.

### CROSS-REFERENCE TO RELATED APPLICATIONS

The present application claims the benefit of U.S. Provisional Patent Application Ser. No. 63/465,220, entitled “EDITABLE FORM FIELD DETECTION,” filed May 9, 2023, which is hereby incorporated herein by reference in its entirety and made part of the present U.S. Utility Patent Application for all purposes.

### TECHNICAL FIELD

The present description generally relates to processing text data on electronic devices, including text data from image files.

### BACKGROUND

An electronic device such as a laptop, tablet, or smartphone, may be configured to access text data via a variety of formats, including images.

### BRIEF DESCRIPTION OF THE DRAWINGS

Certain features of the subject technology are set forth in the appended claims. However, for the purpose of explanation, several implementations of the subject technology are set forth in the following figures.

FIG. 1 illustrates an example network environment, in accordance with one or more implementations.

FIG. 2 depicts an example electronic device that may implement the subject methods and systems, in accordance with one or more implementations.

FIG. 3 depicts an example unstructured form data, in accordance with one or more implementations.

FIG. 4 depicts structured form data based on the unstructured form data of FIG. 3, in accordance with one or more implementations.

FIG. 5 depicts a flow diagram of an example process for generating structured form data from image data, in accordance with one or more implementations.

FIG. 6 depicts an example electronic system with which aspects of the present disclosure may be implemented, in accordance with one or more implementations.

### DETAILED DESCRIPTION

The detailed description set forth below is intended as a description of various configurations of the subject technology and is not intended to represent the only configurations in which the subject technology can be practiced. The appended drawings are incorporated herein and constitute a part of the detailed description. The detailed description includes specific details for the purpose of providing a thorough understanding of the subject technology. However, the subject technology is not limited to the specific details set forth herein and can be practiced using one or more other implementations. In one or more implementations, structures and components are shown in block diagram form in order to avoid obscuring the concepts of the subject technology.

Forms are widely used for data collection purposes in various domains, such as government, education, healthcare, and finance. However, in some cases, these forms may not have digitally defined and/or editable fields, which can pose a significant challenge for data processing and management. For instance, a digital representation of a form (such as a scanned portable document format (PDF) or a JPEG) may lack digital structure and therefore may not include editable fields that can be filled electronically. This may force individuals to print the form, manually fill it in, and then scan it back into a digital format, which could lead to inefficiencies and/or errors. Manually adding fields or other structure to the file is not a viable solution either, as it is time-consuming, error-prone, and not scalable (e.g., difficult to collect, process, and/or store the information input to the form when a large number of users are filling out a particular form). Thus, there is a need for a solution that can efficiently and accurately add electronic field structure to such forms without the need for manual intervention, enabling users to fill them electronically and streamline the data collection process.

The present disclosure relates to automatic recognition and structuring of form fields. For example, a trained machine learning model can identify and tag form fields in unstructured or partially structured files that represent forms, such as PDFs, images (e.g., JPEGs), and the like. Identifying form fields may be based on the text of a form (e.g., “surname” may indicate a text box for inputting a surname) and/or based on the layout of the form (e.g., a line may be indicative of a text box and the line's proximity to “surname” may indicate that the text box is for inputting a surname). Once identified, these fields can be used to generate metadata that can be embedded into the file, thereby converting the file into an electronically fillable form. Metadata may include the location of the field (e.g., particular coordinates and/or near “surname”), the name of the field (e.g., “surname”), the type of input received by the field (e.g., text), and the like. In one or more implementations, the metadata can be used to auto-fill fields with information relevant to the user (e.g., filling in the user's surname when they encounter the “surname” field).

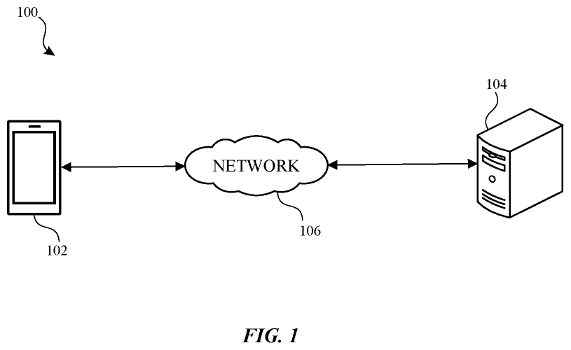

FIG. 1 illustrates an example network environment 100, in accordance with one or more implementations. Not all of the depicted components may be used in all implementations, however, and one or more implementations may include additional or different components than those shown in the figure. Variations in the arrangement and type of the components may be made without departing from the spirit or scope of the claims as set forth herein. Additional components, different components, or fewer components may be provided. In one or more implementations, the subject methods may be performed on the electronic device 102 without use of the network environment 100.

The network environment 100 may include an electronic device 102 and one or more servers (e.g., a server 104). The network 106 may communicatively (directly or indirectly) couple the electronic device 102 and the server 104. In one or more implementations, the network 106 may be an interconnected network of devices that may include, or may be communicatively coupled to, the Internet. For explanatory purposes, the network environment 100 is illustrated in FIG. 1 as including the electronic device 102 and the server 104; however, the network environment 100 may include any number of electronic devices and/or any number of servers communicatively coupled to each other directly or via the network 106.

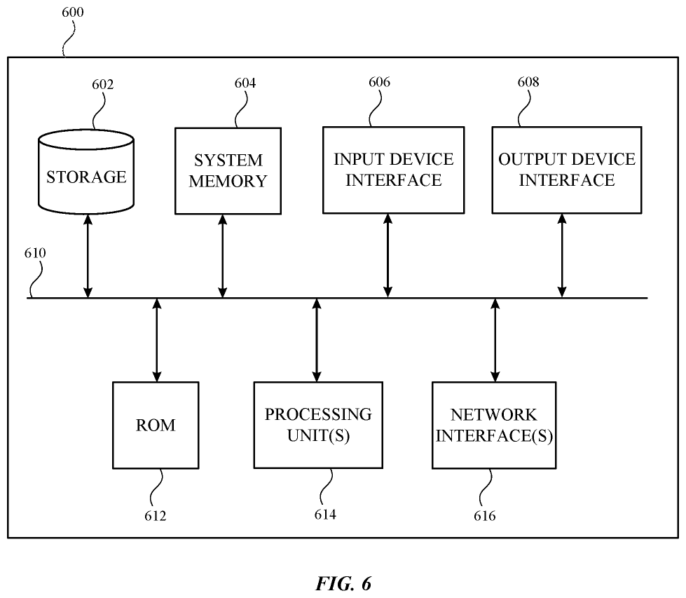

The electronic device 102 may be, for example, a desktop computer, a portable computing device such as a laptop computer, a smartphone, a peripheral device (e.g., a digital camera, headphones), a tablet device, standalone videoconferencing hardware, a wearable device such as a watch, a band, and the like, or any other appropriate device that includes, for example, one or more wireless interfaces, such as WLAN radios, cellular radios, Bluetooth radios, Zigbee radios, near field communication (NFC) radios, and/or other wireless radios. In one or more implementations, the electronic device 102 may include a text recognition module (and/or circuitry) and one or more applications. In FIG. 1, by way of example, the electronic device 102 is depicted as a smartphone. The electronic device 102 may be, and/or may include all or part of, the electronic system discussed below with respect to FIG. 6. In one or more implementations, the electronic device 102 may include a camera and a microphone and may generate and/or provide data (e.g., images or audio) for accessing (e.g., identifying) text data for processing (e.g., via a processor or the server 104).

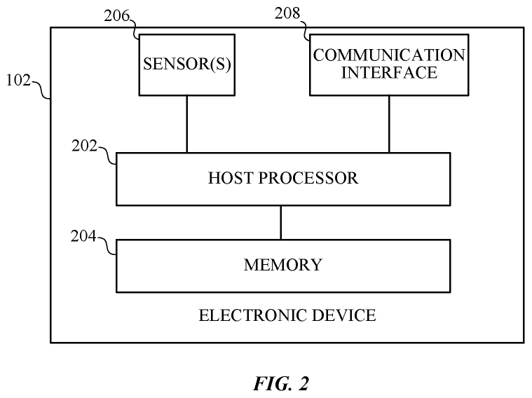

FIG. 2 depicts an electronic device 102 that may implement the subject methods and systems, in accordance with one or more implementations. For explanatory purposes, FIG. 2 is primarily described herein with reference to the electronic device 102 of FIG. 1. However, this is merely illustrative, and features of the electronic device of FIG. 2 may be implemented in any other electronic device for implementing the subject technology (e.g., the server 104). Not all of the depicted components may be used in all implementations, however, and one or more implementations may include additional or different components than those shown in FIG. 2. Variations in the arrangement and type of the components may be made without departing from the spirit or scope of the claims as set forth herein. Additional components, different components, or fewer components may be provided.

The electronic device 102 may include one or more of a host processor 202, a memory 204, one or more sensor(s) 206, and/or a communication interface 208. The host processor 202 may include suitable logic, circuitry, and/or code that enable processing data and/or controlling operations of the electronic device 102. In this regard, the host processor 202 may be enabled to provide control signals to various other components of the electronic device 102. The host processor 202 may also control transfers of data between various portions of the electronic device 102. The host processor 202 may further implement an operating system or may otherwise execute code to manage operations of the electronic device 102.

The memory 204 may include suitable logic, circuitry, and/or code that enable storage of various types of information such as received data, generated data, code, and/or configuration information. The memory 204 may include, for example, random access memory (RAM), read-only memory (ROM), flash, and/or magnetic storage. The memory 204 may store machine-readable instructions for performing methods described herein. In one or more implementations, the memory 204 may store text data (e.g., as provided by the server 104). The memory 204 may further store portions of text data for intermediate storage (e.g., in buffers) as the text data is being processed.

The memory 204 may include one or more machine learning model (e.g., supervised learning models, transformer models, and the like) trained to identify and tag form fields in unstructured or partially structured files that represent forms, such as PDFs, images (e.g., JPEGs), and the like. For example, a machine learning model may be an object recognition model trained to recognize form fields using a supervised learning approach. This may involve training the model on a large dataset of labeled form images that contain examples of different types of form fields, such as checkboxes, radio buttons, text boxes, dropdown menus, and the like.

The training process may include one or more steps such as preprocessing the training form images to extract their form fields and associated labels, which may involve segmenting the form fields from the background and identifying the text that corresponds to each field label. The model may be trained using a training dataset that includes labeled examples of each type of form field to cause the model to adjust weights and/or other parameters thereby causing the model to recognize the shape, size, position, and/or other semantic and/or geometric characteristics of each field and to associate each field with its corresponding label based on such characteristics. During the training process, the model's performance may be evaluated on a validation dataset to verify that it generalizes well to other examples of form data. The training process may be repeated with different weights and/or other parameters until the model achieves a threshold level of performance on the validation dataset. Once the model has been trained, it may be used to recognize form fields and/or field labels in new, unlabeled form data. The model may analyze the form data, identify the location and shape of each field, and/or associate it with its corresponding label, thereby allowing the form data to be structured and processed automatically.

The sensor(s) 206 may include one or more microphones and/or cameras. The microphones may obtain audio signals corresponding to text data. The cameras may be used to obtain image files corresponding to text data. For example, the cameras may obtain images of a form having text and fields, which may be processed into text data that can be utilized by the host processor 202 for generating form data.

The communication interface 208 may include suitable logic, circuitry, and/or code that enables wired or wireless communication, such as between the electronic device 102 and the server 104. The communication interface 208 may include, for example, one or more of a Bluetooth communication interface, an NFC interface, a Zigbee communication interface, a WLAN communication interface, a USB communication interface, a cellular interface, or generally any communication interface.

In one or more implementations, one or more of the host processor 202, the memory 204, the sensor(s) 206, the communication interface 208, and/or one or more portions thereof may be implemented in software (e.g., subroutines and code), may be implemented in hardware (e.g., an Application Specific Integrated Circuit (ASIC), a Field Programmable Gate Array (FPGA), a Programmable Logic Device (PLD), a controller, a state machine, gated logic, discrete hardware components, or any other suitable devices) and/or a combination of both.

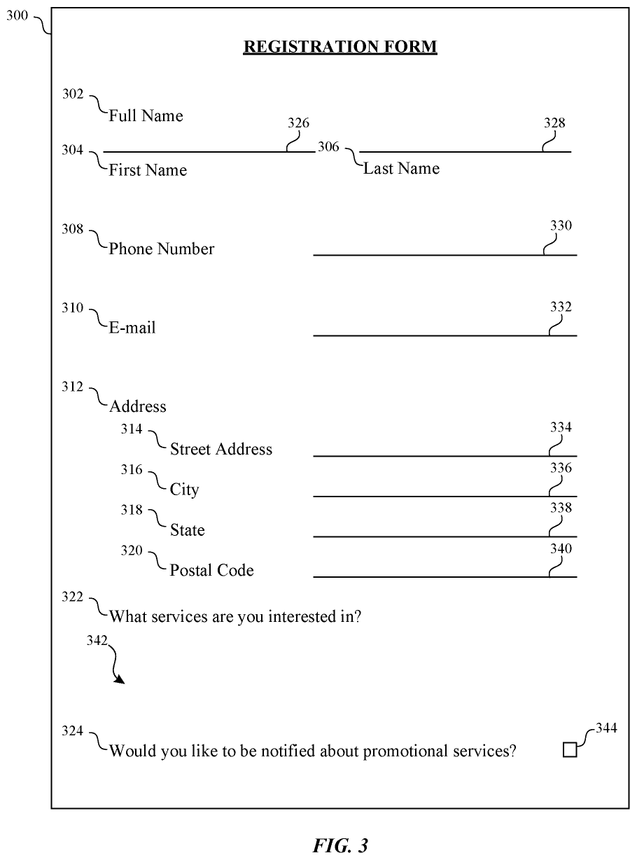

FIG. 3 depicts an example unstructured form data 300, in accordance with one or more implementations. The unstructured form data 300 may be obtained (e.g., retrieved, accessed, downloaded, received, and/or the like) from a file, data structure, or from any other digital medium. The unstructured form data 300 is unstructured in that it does not include data (e.g., metadata) for manipulation of the information and features depicted, such as data identifying fillable fields. By contrast, structured form data may include a fillable PDF in which a user may input data into defined, fillable fields of form data.

For example, the unstructured form data may include an image of a registration form. The image may depict text such as field labels 302-324 and editable form fields 326-344 corresponding to the field labels 302-324. However, the form data may lack data that allows for digital interaction with the form, such as highlighting text of the field labels 302-324 and/or inputting text into fillable fields corresponding to the editable form fields 326-344, and, as such, the form data is unstructured. By contrast, structured form data may include a digital representation of a form that includes editable form fields and/or elements that can be interacted with, such as through highlighting, navigation, and/or data validation. With structured form data, for example, users can easily interact with the form, inputting text and making selections in the editable fields, navigating through the fields using keyboard or mouse inputs, and highlighting text in the field labels for clarity.

To allow for digital text input into the unstructured form, a user may have to manually create structured form data by manually placing editable form fields in the appropriate areas (e.g., editable form fields 326-344) and then manually inputting data into the editable form fields. Additionally, the user may have to manually determine the appropriate presentation of the text in the editable form fields. For example, the user may want the text of an editable form field to be the same as the text of the field label, in which case the user may have to manually determine and set the font as black, 12 point, “Times New Roman” font.

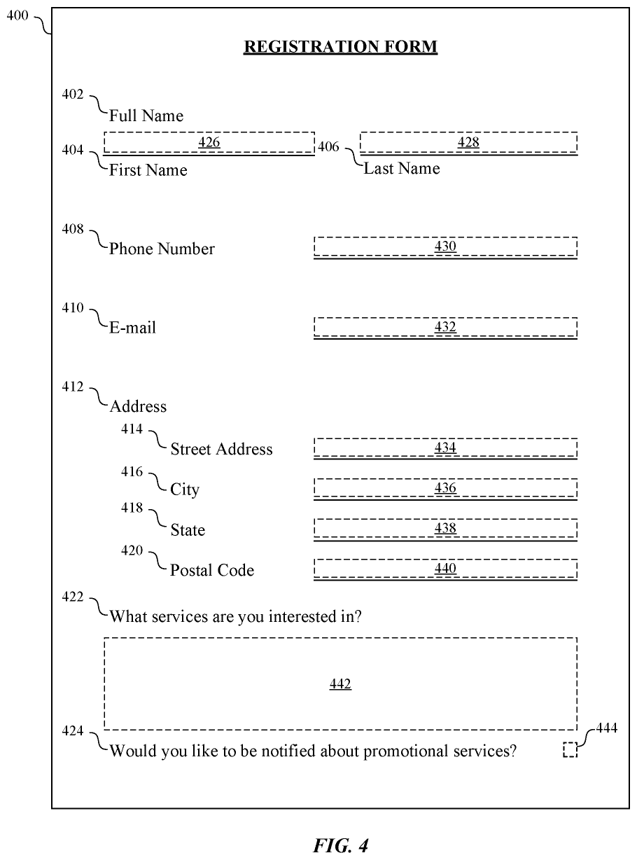

FIG. 4 depicts structured form data 400 based on the unstructured form data 300 of FIG. 3, in accordance with one or more implementations. An electronic device (e.g., electronic device 102) may receive and process the unstructured form data 300 (e.g., implementing the example process 500 discussed further below) and output the structured form data 400. The structured form data 400 may include some or all of the unstructured form data 300, such as the image of the form. The image of the form may be preprocessed before the structured form data 400 is generated. Preprocessing may include improving the visual quality of the image data by applying various techniques to correct issues such as noise, blur, or distortion. Techniques may include deskewing (e.g., applying rotation to the image data to straighten any skewed or tilted lines), cropping (e.g., removing borders or margins around the image data), scaling (e.g., resizing the image data to a standardized size), and/or perspective correction (e.g., applying a perspective transform to place corners or edges of the image data within a predetermined distance from each other).

The structured form data 400 may also include metadata that provides structure to the image data. The metadata may include one or more objects or other data structures that define the various aspects of a form (e.g., a PDF form), including form fields, field labels, and their properties (e.g., appearance).

The editable form fields may include a type of field (e.g., text field, checkbox, radio button, etc.), field name, and default value (if any). Each editable form field may have a name that is used to identify it within the PDF document, and the name may be based on corresponding field labels presented on the form. The properties of each editable form field may be stored in objects that define various aspects of the field, such as the font size, color, formatting, and validation rules. They may also include annotations that define the appearance of the editable form fields on the form, such as the size, position, and style of the field border and fill.

To generate the structured form data 400, the electronic device 102 may recognize the field labels 302-326 and the editable form fields 328-346 in the unstructured form data 300. To recognize text in an image, a machine learning model may employ Optical Character Recognition (OCR). The OCR algorithm uses various techniques to analyze the image and segment it into individual characters, which are then recognized and converted into machine-readable text. One approach for OCR is using Convolutional Neural Networks (CNNs), which are trained on large datasets of labeled images to learn the patterns and features that are associated with different characters. The CNN model may then apply these learned patterns to new images to identify and recognize the characters present in them.

To recognize editable form fields in an image, a machine learning model may use techniques such as object detection and image segmentation. For example, object detection algorithms use machine learning models to identify the location of objects in an image, and then a segmentation algorithm may be applied to separate out the editable form fields from other elements in the image. The segmentation process may use features such as color, texture, and shape to separate the editable form fields from other elements. The model may then classify the detected editable form fields based on their type, such as text boxes, radio buttons, checkboxes, or dropdown menus, based on the visual features of each element. The model can be trained on a labeled dataset that contains examples of different types of editable form fields to learn the visual features associated with each type.

The subject technology may also recognize relationships between the field labels 402-424 and the editable form fields 426-444. The relationships may be determined based on the attributes of the text data and/or the editable form fields. The attributes may be learned characteristics utilized in a machine learning-based approach and/or rules utilized in a heuristics-based approach.

The attributes may include semantic information. Semantic information may include the subject matter (e.g., meaning of the words) of the field label. For example, the field label 402 reads “Full Name,” includes capitalization of each word, and does not include punctuation. “Full Name” suggests that there may be an editable form field for a user's full name as many forms request a name. The capitalization of each word suggests that it is not part of a sentence, which suggests that it may be a field label. Because “Full Name” suggests that there may be components to a name, “First Name” and “Last Name” may be sub-labels indicating a hierarchy of editable form fields (e.g., editable form fields 426-428) that collectively represent “Full Name.” Semantic information may also include punctuation. For example, field label 422 reads, “What services are you interested in?” The question mark suggests that the form is soliciting a response from the user and thus may include an editable form field for the user to input their response. Other semantic information may include, for example, symbols, capitalization, word count, part of speech tags (e.g., noun, verb, adjective, etc. as determined by natural language processing part of speech tagging algorithm), text format (e.g., underlined, bolded, or italicized), and/or any other information relating to the semantics of the text data.

The attributes may also include geometric information. Geometric information may include the location of a field label relative to an editable form field. For example, the field label 404 may be the most proximate field label to editable form field 426 and may be positioned directly below the editable form field 426 suggesting that it corresponds to the editable form field 426. As another example, the field label 408 may correspond to the editable form field 430 because the field label 408 is to the left of the editable form field 430 and because they are on the same line (e.g., horizontal plane). Other geometric information may include, for example, line starting location, line height, line spatial orientation, line length, line spacing, and/or any other information relating to the geometry of lines.

In the example shown in FIG. 4, the field label 402 may be associated with field labels 404-406, which may correlate to editable form fields 426-428, respectively. The field labels 408-410 may correlate to editable form fields 430-432, respectively. The field label 412 may be associated with the field labels 414-420, which may correlate to editable form fields 434-440, respectively. The field labels 422-424 may correlate to the editable form fields 442-444, respectively. In some implementations, as shown in FIG. 4, the editable form fields 426-444 may be indicated by visible bounding boxes to provide a visual cue that the editable form fields 426-444 are identified and interactive (e.g., fillable).

In addition to determining correspondences between field label and editable form field, the text attributes may be utilized to determine the validation and/or presentation of input information.

Validating information that a user input into an editable form field may include verifying the inclusion of particular characters (e.g., ‘@’ for the editable form field 432 corresponding to the field label 410), a character minimum/maximum (e.g., 10 digit phone number for editable form field 430 corresponding to the field label 408), an input from a predefined set of inputs (e.g., a two letter state abbreviation from the United States of America in editable form field 438 corresponding to 418), and any other requirements for input information.

The presentation of input information may include the font, size, style (e.g., regular, bold, or italicized), color, line height, case, and any other font attribute. The information that is input into an editable form field may appear in a manner similar to the text in the image (e.g., a font size of a corresponding field label or most commonly used in the form). For example, the information input into an editable form field may be the same font and font size as the field label to which the editable form field corresponds. Additionally, the font attributes may be modified to suit the type of input in the editable form field. For example, because editable form field 438 corresponds to field label 418, the editable form field 438 may be formatted as a dropdown list of states (e.g., where the user may make a selection) rather than a text box. As another example, editable form field 442 may expect multiple lines of text (e.g., because of the distance between field label 422 and field label 424), and so the font size may dynamically change based on the amount of text input so that the input may remain between a minimum and maximum font size threshold. As yet another example, if an editable form field is unbounded (e.g., is not contained within a box, such as editable form field 426-440), the editable form field (and/or its bounding box) may be resized to accommodate for inputs such as signature drawings.

With the recognized information (e.g., text attributes and/or field label and editable form field correspondences), metadata may be generated and embedded into a file in association with the image of the form to provide the form with structure thereby allowing the form to be filled, processed, or otherwise manipulated in a digital environment. For example, the structured form data 400 of the registration form may be filled on an electronic device (e.g., the electronic device 102). The electronic device may use information from an existing data structure (e.g., a contacts app) to auto-fill information in the form. For example, the electronic device may retrieve a phone number from a contact in the contacts app having the name indicated in editable form fields 426-428 and the electronic device may input the retrieved phone number into the editable form field 430.

In some implementations, the recognized information may be modified. A user may correct the recognized information by changing one or more attributes of one or more editable form fields. For example, the user may move the location of an editable form field automatically generated by the electronic device to a location more suitable for the editable form field and may change the font size of the editable form field to better align with the corresponding field label.

A user may also or instead add or remove one or more editable form fields. The electronic device 102 may present options to remove an editable form field after it has been identified. The electronic device 102 may present options to add an editable form field in the case it has not been identified. When the user adds a new editable form field, the electronic device 102 may utilize geometric information to determine the appropriate placement of the editable form field within the form data. For example, the electronic device 102 may consider the size and shape of the editable form field, ensuring that it does not overlap with other editable form fields and fits within the existing structure of the form. In addition to geometric information, the electronic device 102 may also utilize semantic information to determine the proper text attributes of the new editable form field. This may involve analyzing the surrounding text and determining the most appropriate field label for the editable form field. For example, if the user adds a new editable form field next to the “Email Address” field label, the electronic device 102 may use semantic information to associate the new editable form field with the “Email Address” field label. This helps the new editable form field be properly placed within the form and labeled in a way that is both accurate and intuitive.

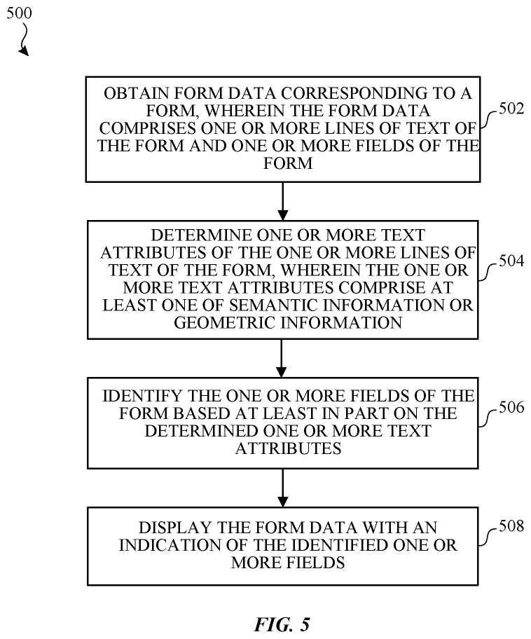

FIG. 5 depicts a flow diagram of an example process 500 for generating structured form data from image data, in accordance with one or more implementations. For explanatory purposes, the process 500 is primarily described herein with reference to the electronic device 102 of FIG. 1. However, the process 500 is not limited to the electronic device 102, and one or more blocks of the process 500 may be performed by one or more other components of the electronic device 102 and/or other suitable devices. Further, for explanatory purposes, the blocks of the process 500 are described herein as occurring sequentially or linearly. However, multiple blocks of the process 500 may occur in parallel. In addition, the blocks of the process 500 need not be performed in the order shown and/or one or more blocks of the process 500 need not be performed and/or can be replaced by other operations. In one or more implementations, an application stored on the electronic device 102 performs the process 500 by calling APIs provided by the operating system and/or another application on the electronic device 102. In one or more implementations, the operating system of the electronic device 102 performs the process 500 by processing API calls provided by the application stored on the electronic device 102. In one or more implementations, the application stored on the electronic device 102 fully performs the process 500 without making any API calls to the operating system of the electronic device 102.

At block 502, the electronic device 102 may receive, access, download, retrieve, or otherwise obtain form data, which may be unstructured. The form data may be obtained from a data structure such as an image (e.g., a scanned image or photo of a form) or a document (e.g., a file). For example, the electronic device 102 may download an image of a form from a server (e.g., the server 104), or a user of the electronic device 102 may capture an image of a form using a camera of the electronic device 102.

The form may include one or more lines of text and one or more editable form fields (e.g., for receiving text, images, checkmarks, and/or other information). However, the lines of text and editable form fields in the form data, by themselves, may not be usable by the electronic device 102 (e.g., as interactive editable form fields) because they lack appropriate structure and/or context data. For example, consider an image of a form that contains lines of text and editable form fields, the lines of text may not be organized in a way that the electronic device 102 can easily distinguish between different sections of the form. Similarly, the editable form fields may not be labeled or structured in a way that is easily identifiable by the electronic device 102 (e.g., for editing). Without the structure and context data provided by, for example, a machine learning model, users may manually fill in the editable form fields, increasing the risk of errors and inconsistencies in the data collected.

At block 504, the electronic device 102 may determine one or more text attributes of one or more lines of the form. Text attributes may include semantic information and/or geometric information. Semantic information may refer to the meaning or context of the text in the form. For example, the semantic information of a line of text in a form may indicate that the text represents a question or a field label, or it may indicate that the text represents a specific type of information, such as a name or an address. Semantic information can help a machine learning model to identify and classify the different sections of the form and understand the relationship between the different editable form fields. The semantic information may include meaning, punctuation, symbols, capitalization, word count, part of speech tags, and/or any other information relating to the semantics of the text data.

Geometric information, on the other hand, may refer to the spatial relationships of the text and editable form fields in the form. This can include information such as the position, size, and orientation of the text (e.g., field labels) and editable form fields in relation to each other and/or other elements of the form. Geometric information can help the machine learning model to understand the layout and structure of the form and identify the location and shape of the different editable form fields. The geometric information may include line starting location, line height, line spatial orientation, line length, line spacing, and/or any other information relating to the geometry of lines as displayed/formatted in the file, image, etc.

In one or more implementations, the text attributes may include a language corresponding to the text data. The process 500 may then be performed based on the reading order that corresponds with the language. For example, the electronic device 102 may utilize a natural language processing model (e.g., a language detection model) to determine that the language of the text data is traditional Chinese and modify the process 500 such that the lines of text are analyzed from right to left (because the lines are vertical) as opposed to top to bottom (if the lines are horizontal).

At block 506, the electronic device 102 may detect and/or identify one or more editable form fields (e.g., the editable form fields 426-444) of the form based at least in part on the text attributes from block 504. An object recognition model may be used to identify editable form fields in the form. The electronic device 102 may first train the model on a dataset of training forms with known editable form field locations, field label locations, and/or text attributes. During training, the model may learn to recognize the visual features of the training form fields, such as their size and shape, and use this information to identify fields in new forms.

Once the model has been trained, it may be used to analyze the form and identify regions of the form that are likely to contain editable form fields and/or sub-fields. The model may use its learned features to identify regions that match the visual characteristics of editable form fields, such as rectangular or circular shapes with clear edges. In some implementations, the model may indicate the location of identified form fields and/or sub-fields with a bounding box around the identified form fields as shown in FIG. 4.

In one or more implementations, the model may also be used to analyze the identified regions to identify sub-regions that are likely to contain editable form sub-fields. For example, the model may identify a field in the form for entering a social security number (SSN), which includes one sub-field for inputting the first three digits of the SSN, a second sub-field for inputting the next two digits of the SSN, and a third sub-field for inputting the last four digits of the SSN. The sub-fields may be identified, for example, based on geometric information (e.g., spacing) between the grouping of digits of the SSN and/or the semantic information (e.g., SSN is known to be grouped into three sets of digits, totaling nine digits).

After identifying potential editable form fields in the form, the electronic device 102 may use natural language processing techniques, for example, to analyze the text in the form along with its attributes (e.g., semantic and/or geometric information) and determine whether it is a field label (e.g., the field labels 402-424) and, if so, which editable form field it is associated with. For example, if the object recognition model identifies a rectangular region in the form (e.g., an editable form field), the natural language processing component could analyze the text within a threshold distance of that region to determine if the rectangular region corresponds to a name, address, or some other type of field label.

By combining object recognition with natural language processing, the electronic device 102 can accurately identify and tag editable form fields in the form, even if the form lacks a structured layout or consistent design. This approach may be particularly useful for processing handwritten forms or forms with non-standard layouts, which may be more difficult to analyze using traditional form structuring techniques.

In some implementations, the form may already include interactive editable form fields, and information (e.g., semantic and/or geometric, metadata, and the like) relating to the included interactive editable form fields may be used to assist the machine learning model in identifying and tagging other editable form fields in the form. For example, identified and tagged form fields may not overlap with existing interactive editable form fields. As another example, information relating to the included interactive editable form fields may be used to predict attributes of identified and tagged form fields such as content type, font size, global tab order, and the like.

In some implementations, the form may already include interactive editable form fields, and the machine learning model may correct or determine one or more attributes of one or more of the included interactive editable form fields. For example, if an included interactive editable form field has a content type that does not match an expected content type for its associated field label, the machine learning model may generate and assign a proper content type to the field. As another example, if an included interactive editable form field has missing attributes, the machine learning model may predict and assign proper attributes to the field.

At block 508, the electronic device 102 may display the form data with one or more indications of the identified editable form fields. Indications may include notifications, icons, colors, interactions, events, and/or any other visual cues or navigation aids that indicate that the editable form fields are electronically usable. For example, the electronic device 102 may highlight or outline the identified editable form fields with a contrasting color or border to visually separate the editable form fields from the rest of the form and make them more visible to the user. As another example, the electronic device 102 could display a label or tooltip next to each editable form field, indicating what type of information should be entered in that field.

With the recognized information (e.g., text attributes and/or field label and editable form field correspondences), the electronic device 102 may generate metadata for the file data. The metadata may include metadata for one or more of the identified form fields, which may include a location (e.g., spatial orientation) in the form data, a font (e.g., type, size, and/or style), a name of the editable form field, an input type (e.g., the editable form field may expect a phone number), and/or any other attribute of the editable form field. The metadata may also or instead include metadata for one or more of the identified field labels and may include a location in the form data, a font, and/or any other attribute of the field label.

The metadata may be embedded into a file in association with the form data (e.g., the image of the form) to provide the form with structure thereby allowing the form to be filled or otherwise manipulated in a digital environment, such as across different applications and/or across different electronic devices. For example, the structured form data 400 of the registration form may be filled on an electronic device 102. The electronic device 102 may use information from an existing data structure (e.g., a contacts app) to auto-fill information in the form. For example, the electronic device 102 may retrieve a phone number from a contact in the contacts app having the name indicated in editable form fields 426-428 and the electronic device 102 may input the retrieved phone number into the editable form field 430.

In some implementations, the form may be provided to an application or a system process. An application or system process may include a file. For example, the output data may be written to an editable PDF file and stored. An application or system process may also or instead include a data structure. For example, the output data may be written to a buffer in memory. An application or system process may also or instead include a translation process. For example, a machine learning model trained to translate a first language to a second language may receive as input the form data including text data in the first language and output the form data in the second language. An application or system process may also or instead include a screen reading process. For example, the output data may correspond to form data in an audio format and be used as an input to a machine learning model trained to convert text and form fields to speech. An application or system process may also or instead include a virtual assistant process. For example, the form data may be used as a request to a virtual assistant that helps fill in the form data. In one or more implementations, the processes may be incorporated with one another. For example, the translation process may translate the form and the system may write the translated form to a PDF file.

FIG. 6 depicts an example electronic system 600 with which aspects of the present disclosure may be implemented, in accordance with one or more implementations. The electronic system 600 can be, and/or can be a part of, any electronic device for generating the features and processes described in reference to FIGS. 1-5, including but not limited to a laptop computer, tablet computer, smartphone, and wearable device (e.g., smartwatch, fitness band). The electronic system 600 may include various types of computer-readable media and interfaces for various other types of computer-readable media. The electronic system 600 includes one or more processing unit(s) 614, a persistent storage device 602, a system memory 604, an input device interface 606, an output device interface 608, a bus 610, a ROM 612, one or more processing unit(s) 614, one or more network interface(s) 616, and/or subsets and variations thereof.

The bus 610 collectively represents all system, peripheral, and chipset buses that communicatively connect the numerous internal devices of the electronic system 600. In one or more implementations, the bus 610 communicatively connects the one or more processing unit(s) 614 with the ROM 612, the system memory 604, and the persistent storage device 602. From these various memory units, the one or more processing unit(s) 614 retrieves instructions to execute and data to process in order to execute the processes of the subject disclosure. The one or more processing unit(s) 614 can be a single processor or a multi-core processor in different implementations.

The ROM 612 stores static data and instructions that are needed by the one or more processing unit(s) 614 and other modules of the electronic system 600. The persistent storage device 602, on the other hand, may be a read-and-write memory device. The persistent storage device 602 may be a non-volatile memory unit that stores instructions and data even when the electronic system 600 is off. In one or more implementations, a mass-storage device (such as a magnetic or optical disk and its corresponding disk drive) may be used as the persistent storage device 602.

In one or more implementations, a removable storage device (such as a floppy disk, flash drive, and its corresponding disk drive) may be used as the persistent storage device 602. Like the persistent storage device 602, the system memory 604 may be a read-and-write memory device. However, unlike the persistent storage device 602, the system memory 604 may be a volatile read-and-write memory, such as RAM. The system memory 604 may store any of the instructions and data that one or more processing unit(s) 614 may need at runtime. In one or more implementations, the processes of the subject disclosure are stored in the system memory 604, the persistent storage device 602, and/or the ROM 612. From these various memory units, the one or more processing unit(s) 614 retrieves instructions to execute and data to process in order to execute the processes of one or more implementations.

The bus 610 also connects to the input device interfaces 606 and output device interfaces 608. The input device interface 606 enables a user to communicate information and select commands to the electronic system 600. Input devices that may be used with the input device interface 606 may include, for example, alphanumeric keyboards, touch screens, and pointing devices (also called “cursor control devices”). The output device interface 608 may enable, for example, the display of images generated by electronic system 600. Output devices that may be used with the output device interface 608 may include, for example, printers and display devices, such as a liquid crystal display (LCD), a light emitting diode (LED) display, an organic light emitting diode (OLED) display, a flexible display, a flat panel display, a solid-state display, a projector, or any other device for outputting information.

One or more implementations may include devices that function as both input and output devices, such as a touchscreen. In these implementations, feedback provided to the user can be any form of sensory feedback, such as visual feedback, auditory feedback, or tactile feedback; and input from the user can be received in any form, including acoustic, speech, or tactile input.

Finally, as shown in FIG. 6, the bus 610 also couples the electronic system 600 to one or more networks and/or to one or more network nodes through the one or more network interface(s) 616. In this manner, the electronic system 600 can be a part of a network of computers (such as a local area network, a wide area network, an Intranet, or a network of networks, such as the Internet). Any or all components of the electronic system 600 can be used in conjunction with the subject disclosure.

Implementations within the scope of the present disclosure can be partially or entirely realized using a tangible computer-readable storage medium (or multiple tangible computer-readable storage media of one or more types) encoding one or more instructions. The tangible computer-readable storage medium also can be non-transitory in nature.

The computer-readable storage medium can be any storage medium that can be read, written, or otherwise accessed by a general purpose or special purpose computing device, including any processing electronics and/or processing circuitry capable of executing instructions. For example, without limitation, the computer-readable medium can include any volatile semiconductor memory, such as RAM, DRAM, SRAM, T-RAM, Z-RAM, and TTRAM. The computer-readable medium also can include any non-volatile semiconductor memory, such as ROM, PROM, EPROM, EEPROM, NVRAM, flash, nvSRAM, FeRAM, FeTRAM, MRAM, PRAM, CBRAM, SONOS, RRAM, NRAM, racetrack memory, FJG, and Millipede memory.

Further, the computer-readable storage medium can include any non-semiconductor memory, such as optical disk storage, magnetic disk storage, magnetic tape, other magnetic storage devices, or any other medium capable of storing one or more instructions. In one or more implementations, the tangible computer-readable storage medium can be directly coupled to a computing device, while in other implementations, the tangible computer-readable storage medium can be indirectly coupled to a computing device, e.g., via one or more wired connections, one or more wireless connections, or any combination thereof.

Instructions can be directly executable or can be used to develop executable instructions. For example, instructions can be realized as executable or non-executable machine code or as instructions in a high-level language that can be compiled to produce executable or non-executable machine code. Further, instructions also can be realized as or can include data. Computer-executable instructions also can be organized in any format, including routines, subroutines, programs, data structures, objects, modules, applications, applets, functions, etc. As recognized by those of skill in the art, details including, but not limited to, the number, structure, sequence, and organization of instructions can vary significantly without varying the underlying logic, function, processing, and output.

While the above discussion primarily refers to microprocessors or multi-core processors that execute software, one or more implementations are performed by one or more integrated circuits, such as ASICs or FPGAs. In one or more implementations, such integrated circuits execute instructions that are stored on the circuit itself.

Those of skill in the art would appreciate that the various illustrative blocks, modules, elements, components, methods, and algorithms described herein may be implemented as electronic hardware, computer software, or combinations of both. To illustrate this interchangeability of hardware and software, various illustrative blocks, modules, elements, components, methods, and algorithms have been described above generally in terms of their functionality. Whether such functionality is implemented as hardware or software depends upon the particular application and design constraints imposed on the overall system. Skilled artisans may implement the described functionality in varying ways for each particular application. Various components and blocks may be arranged differently (e.g., arranged in a different order, or partitioned in a different way), all without departing from the scope of the subject technology.

It is understood that any specific order or hierarchy of blocks in the processes disclosed is an illustration of example approaches. Based upon design preferences, it is understood that the specific order or hierarchy of blocks in the processes may be rearranged, or that all illustrated blocks be performed. Any of the blocks may be performed simultaneously. In one or more implementations, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products.

As described above, one aspect of the present technology is the gathering and use of data available from specific and legitimate sources for processing text data. The present disclosure contemplates that in some instances, this gathered data may include personal information data that uniquely identifies or can be used to identify a specific person. Such personal information data can include demographic data, location-based data, online identifiers, telephone numbers, email addresses, home addresses, images, videos, audio data, data or records relating to a user's health or level of fitness (e.g., vital signs measurements, medication information, exercise information), date of birth, or any other personal information.

The present disclosure recognizes that the use of such personal information data, in the present technology, can be used to the benefit of users. For example, the personal information data can be used for processing text data. Accordingly, the use of such personal information data may facilitate transactions (e.g., online transactions). Further, other uses for personal information data that benefit the user are also contemplated by the present disclosure. For instance, health and fitness data may be used, in accordance with the user's preferences to provide insights into their general wellness or may be used as positive feedback to individuals using technology to pursue wellness goals.

The present disclosure contemplates that those entities responsible for the collection, analysis, disclosure, transfer, storage, or other use of such personal information data will comply with well-established privacy policies and/or privacy practices. In particular, such entities would be expected to implement and consistently apply privacy practices that are generally recognized as meeting or exceeding industry or governmental requirements for maintaining the privacy of users. Such information regarding the use of personal data should be prominently and easily accessible by users and should be updated as the collection and/or use of data changes. Personal information from users should be collected for legitimate uses only. Further, such collection/sharing should occur only after receiving the consent of the users or other legitimate basis specified in applicable law. Additionally, such entities should consider taking any needed steps for safeguarding and securing access to such personal information data and ensuring that others with access to the personal information data adhere to their privacy policies and procedures. Further, such entities can subject themselves to evaluation by third parties to certify their adherence to widely accepted privacy policies and practices. In addition, policies and practices should be adapted for the particular types of personal information data being collected and/or accessed and adapted to applicable laws and standards, including jurisdiction-specific considerations which may serve to impose a higher standard. For instance, in the US, collection of or access to certain health data may be governed by federal and/or state laws, such as the Health Insurance Portability and Accountability Act (HIPAA); whereas health data in other countries may be subject to other regulations and policies and should be handled accordingly.

Despite the foregoing, the present disclosure also contemplates implementations in which users selectively block the use of, or access to, personal information data. That is, the present disclosure contemplates that hardware and/or software elements can be provided to prevent or block access to such personal information data. For example, in the case of processing text data, the present technology can be configured to allow users to select to “opt-in” or “opt-out” of participation in the collection of personal information data during registration for services or anytime thereafter. In addition to providing “opt-in” and “opt-out” options, the present disclosure contemplates providing notifications relating to the access or use of personal information. For instance, a user may be notified upon downloading an app that their personal information data will be accessed and then reminded again just before personal information data is accessed by the app.

Moreover, it is the intent of the present disclosure that personal information data should be managed and handled in a way to minimize risks of unintentional or unauthorized access or use. Risk can be minimized by limiting the collection of data and deleting data once it is no longer needed. In addition, and when applicable, including in certain health-related applications, data de-identification can be used to protect a user's privacy. De-identification may be facilitated, when appropriate, by removing identifiers, controlling the amount or specificity of data stored (e.g., collecting location data at city level rather than at an address level), controlling how data is stored (e.g., aggregating data across users), and/or other methods such as differential privacy.

Therefore, although the present disclosure broadly covers use of personal information data to implement one or more various disclosed implementations, the present disclosure also contemplates that the various implementations can also be implemented without the need for accessing such personal information data. That is, the various implementations of the present technology are not rendered inoperable due to the lack of all or a portion of such personal information data.

As used in this specification and any claims of this application, the terms “base station,” “receiver,” “computer,” “server,” “processor,” and “memory” all refer to electronic or other technological devices. These terms exclude people or groups of people. For the purposes of the specification, the terms “display” or “displaying” means displaying on an electronic device.

As used herein, the phrase “at least one of” preceding a series of items, with the term “and” or “or” to separate any of the items, modifies the list as a whole, rather than each member of the list (i.e., each item). The phrase “at least one of” does not require selection of at least one of each item listed; rather, the phrase allows a meaning that includes at least one of any one of the items, and/or at least one of any combination of the items, and/or at least one of each of the items. By way of example, the phrases “at least one of A, B, and C” or “at least one of A, B, or C” each refer to only A, only B, or only C; any combination of A, B, and C; and/or at least one of each of A, B, and C.

The predicate words “configured to,” “operable to,” and “programmed to” do not imply any particular tangible or intangible modification of a subject, but, rather, are intended to be used interchangeably. In one or more implementations, a processor configured to monitor and control an operation or a component may also mean the processor being programmed to monitor and control the operation or the processor being operable to monitor and control the operation. Likewise, a processor configured to execute code can be construed as a processor programmed to execute code or operable to execute code.

Phrases such as an aspect, the aspect, another aspect, some aspects, one or more aspects, an implementation, the implementation, another implementation, one or more implementations, one or more implementations, an embodiment, the embodiment, another embodiment, one or more implementations, one or more implementations, a configuration, the configuration, another configuration, some configurations, one or more configurations, the subject technology, the disclosure, the present disclosure, other variations thereof and alike are for convenience and do not imply that a disclosure relating to such phrase(s) is essential to the subject technology or that such disclosure applies to all configurations of the subject technology. A disclosure relating to such phrase(s) may apply to all configurations, or one or more configurations. A disclosure relating to such phrase(s) may provide one or more examples. A phrase such as an aspect or some aspects may refer to one or more aspects and vice versa, and this applies similarly to other foregoing phrases.

The word “exemplary” is used herein to mean “serving as an example, instance, or illustration.” Any implementation described herein as “exemplary” or as an “example” is not necessarily to be construed as preferred or advantageous over other implementations. Furthermore, to the extent that the term “include,” “have,” or the like is used in the description or the claims, such term is intended to be inclusive in a manner similar to the term “comprise” as “comprise” is interpreted when employed as a transitional word in a claim.

All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112, sixth paragraph, unless the element is expressly recited using the phrase “means for” or, in the case of a method claim, the element is recited using the phrase “step for.”

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein but are to be accorded the full scope consistent with the language claims, wherein reference to an element in the singular is not intended to mean “one and only one” unless specifically so stated, but rather “one or more.” Unless specifically stated otherwise, the term “some” refers to one or more. Pronouns in the masculine (e.g., his) include the feminine and neuter gender (e.g., her and its) and vice versa. Headings and subheadings, if any, are used for convenience only and do not limit the subject disclosure.

What is claimed is:

1. A method comprising:
obtaining form data corresponding to a form, wherein the form comprises one or more lines of text of the form and one or more fields of the form;
determining one or more text attributes of the one or more lines of text of the form, wherein the one or more text attributes comprise at least one of semantic information or geometric information;
identifying the one or more fields of the form based at least in part on the determined one or more text attributes; and
displaying the form data with an indication of the identified one or more fields.

2. The method of claim 1, wherein the form data is obtained from at least one of an image or a document.

3. The method of claim 1, wherein the indication comprises a respective bounding box displayed around each of the identified one or more fields.

4. The method of claim 1, wherein identifying the one or more fields comprises:
generating a set of training data, wherein a training instance of the set of training data comprises a training text, a training field, and a training label including training text attributes;
training an object detection model using the set of training data; and
identifying, by the object detection model, the one or more fields.

5. The method of claim 1, wherein the semantic information includes one or more of punctuation, symbols, capitalization, or subject matter.

6. The method of claim 1, wherein the geometric information includes one or more of a line starting location, a line height, a line spatial orientation, a line length, or a line spacing.

7. The method of claim 1, further comprising:
providing the form data to an application or a system process.

8. The method of claim 1, wherein metadata associated with a field comprises one or more of a location in the form data, a font, a name, or an input type.

9. The method of claim 1, further comprising:
obtaining input data based on metadata associated with a field; and
filling the field with the input data.

10. The method of claim 1, further comprising:
generating metadata corresponding to the identified one or more fields; and
storing the metadata in association with the form data.

11. An electronic device comprising:
a memory; and
a processor circuit configured to:
obtain form data corresponding to a form, wherein the form comprises one or more lines of text of the form and one or more fields of the form;
determine one or more text attributes of the one or more lines of text of the form, wherein the one or more text attributes comprise at least one of semantic information or geometric information;
identify the one or more fields of the form based at least in part on the determined one or more text attributes; and
display the form data with an indication of the identified one or more fields.

12. The electronic device of claim 11, wherein the form data is obtained from at least one of an image or a document.

13. The electronic device of claim 11, wherein the indication comprises a respective bounding box displayed around each of the identified one or more fields.

14. The electronic device of claim 11, wherein identifying the one or more fields comprises:
generate a set of training data, wherein a training instance of the set of training data comprises a training text, a training field, and a training label including training text attributes;
train an object detection model using the set of training data; and
identify, by the object detection model, the one or more fields.

15. The electronic device of claim 11, wherein the semantic information includes one or more of punctuation, symbols, capitalization, or subject matter.

16. The electronic device of claim 11, wherein the geometric information includes one or more of a line starting location, a line height, a line spatial orientation, a line length, or a line spacing.

17. The electronic device of claim 11, wherein metadata associated with a field comprises one or more of a location in the form data, a font, a name, or an input type.

18. The electronic device of claim 11, wherein the processor circuit further configured to:
provide the form data to an application or a system process.

19. The electronic device of claim 11, wherein the processor circuit further configured to:
obtain input data based on metadata associated with a field; and
fill the field with the input data.

20. A non-transitory computer-readable medium comprising computer-readable instructions that, when executed by a processor, cause the processor to perform operations comprising:
obtaining form data corresponding to a form, wherein the form comprises one or more lines of text of the form and one or more fields of the form;
determining one or more text attributes of the one or more lines of text of the form, wherein the one or more text attributes comprise at least one of semantic information or geometric information;
identifying the one or more fields of the form based at least in part on the determined one or more text attributes; and
displaying the form data with an indication of the identified one or more fields.
